(19) United States
(12) Patent Application Publication
(10) Pub. No.: US 2024/0184991 A1
(43) Pub. Date: Jun. 6, 2024

(54) GENERATING VARIATIONAL DIALOGUE RESPONSES FROM STRUCTURED DATA FOR CONVERSATIONAL AI SYSTEMS AND APPLICATIONS

(71) Applicant: NVIDIA Corporation, Santa Clara, CA (US)

(72) Inventors: Ameya Sunil Mahabaleshwarkar, Pittsburgh, PA (US); Zhilin Wang, Seattle, WA (US); Oluwatobi Olabiyi, Falls Church, VA (US)

(73) Assignee: NVIDIA Corporation, Santa Clara, CA (US)

(21) Appl. No.: 18/061,027

(22) Filed: Dec. 2, 2022

(51) Int. Cl. G06F 40/35; G06F 16/2455; G06F 40/279; G06F 40/40

(52) U.S. Cl. CPC G06F 40/35; G06F 16/2455; G06F 40/279; G06F 40/40; G06N 3/091

(57) ABSTRACT

In various examples, systems and methods are disclosed relating to generating dialogue responses from structured data for conversational artificial intelligence (AI) systems and applications. Systems and methods are disclosed for training or updating a machine learning model—such as a deep neural network—for deployment using structured data from dialogues of multiple domains. The systems and methods can generate responses to users to provide a more natural user experience, such as by generating alternative outputs that vary in syntax with respect to how the outputs incorporate data used to respond to user utterances, while still accurately providing information to satisfy requests from users.

### BACKGROUND

Natural language processing (NLP) systems can be used to generate dialogue content automatically in response to dialogue inputs. However, conventional NLP systems can have limited effectiveness in providing a natural conversational experience for users. For example, some conventional NLP systems rely on fixed template responses that include one or more placeholders, and the placeholders are filled using structured data. Due the fixed nature of these templates, the responses generated are often rigid or stilted, can be awkward or mechanical, and less naturally conversational than desired. In addition, where a user is seeking a more succinct answer—such as a current temperature—a template for a weather response may include additional information that the user is not interested in, such as a likelihood of precipitation or a daily high or low temperature. This type of additional information may result in a less natural conversational flow, which can also diminish the user experience.

### SUMMARY

Embodiments of the present disclosure relate to generating dialogue responses from structured data for conversational artificial intelligence (AI) systems and applications. Systems and methods are disclosed for training a machine learning model—such as a deep neural network—for deployment using structured data from dialogues of multiple domains (e.g., weather, banking, reservations, etc.).

In contrast to conventional systems, such as those described above, systems and methods in accordance with the present disclosure can handle interactive dialogues responsive to queries from users relating to one or more (e.g., multiple) domains, including multi-turn conversations that may relate to several domains. The systems and methods can generate responses to users to provide a more natural user experience; for example, the machine learning model can be trained to generate alternative outputs that vary in syntax with respect to how they incorporate data used to respond to user utterances, while still accurately providing information to satisfy requests from users, including generating more concise outputs.

At least one aspect relates to a processor. The processor can include one or more circuits to determine, responsive to receiving a query, one or more values for one or more fields corresponding to a domain associated with the query. The one or more circuits can generate, using a neural network and based at least on the query and the one or more values, a response. The one or more circuits can cause, using at least one of a display or an audio speaker device, a presentation of the response.

The one or more values can be determined based at least on accessing one or more application programming interfaces (APIs) associated with the domain. The neural network can be updated by the one or more circuits using ground truth data representative of variational responses to a same set of input data, the same set of input data including one or more training queries and one or more training values corresponding to one or more training fields. The neural network can be updated using training data including a plurality of queries associated with a plurality of domains.

The one or more circuits can generate the response further based at least on a second query and one or more values corresponding to one or more second fields corresponding to the second query. The query can be a first query, and the plurality of fields corresponding to the query can be a plurality of first fields. The second query can be linked to the first query.

The neural network can include at least one of (i) an autoregressive model or (ii) a model having an encoder and a decoder. The neural network can include a large language model (LLM). The neural network can be pre-trained on a plurality of domains prior to being re-trained for a particular domain included in the plurality of domains or separate from the plurality of domains.

At least one aspect relates to a processor. The processor can include one or more circuits to determine, using a neural network and based at least on processing a training data instance including a query and values corresponding to a plurality of fields corresponding to the query, a plurality of estimated responses. The one or more circuits can update one or more parameters of the neural network based at least on comparing the plurality of estimated responses to a plurality of variational sample responses corresponding to the query and the values. The neural network can include at least one of an autoregressive model or a model having an encoder and a decoder.

The plurality of estimated responses can include at least a first estimated response having a first syntax and a second estimated response having a second syntax that is a variant of the first syntax. A syntax of a particular estimated response of the plurality of estimated responses represents at least one of a length of the particular estimated response or an arrangement of one or more values of the values corresponding to the input in the particular estimated response.

The one or more circuits can perform the comparing by evaluating a condition indicative of one or more differences between the plurality of estimated responses and the plurality of sample responses.

A training data set including the training data instance can include a plurality of queries including the query. Each of the plurality of queries can be assigned to at least one domain of a plurality of domains.

The query can be a first query, the plurality of fields corresponding to the query can be a plurality of first fields, and the plurality of sample responses corresponding to the query can be a plurality of first sample responses. A second training data instance include a second query linked to the first query, second values corresponding to a plurality of second fields corresponding to the second query, and a plurality of second sample responses corresponding to the second query. The one or more circuits can further update the one or more parameters of the neural network based at least on the plurality of second sample responses, the second values, and a third query comprising the first query and the second query.

At least one aspect relates to a processor. The processor can include one or more circuits to apply, to a neural network, training data comprising a query, a plurality of fields corresponding to the query, and a plurality of sample responses corresponding to the query and the plurality of fields. The plurality of sample responses can have variations relative to each other. The one or more circuits can train the neural network, responsive to applying the training data, to generate, responsive to receiving (i) an input that relates to a domain of the training data and (ii) a plurality of fields corresponding to the input, a plurality of alternative outputs having variations relative to each other in syntax of incorporating one or more fields of the plurality of fields corresponding to the input.

The plurality of alternative outputs can include at least a first output having a first syntax and a second output having a second syntax that is varied from the first syntax. The syntax of a particular output of the plurality of outputs can represent at least one of a length of the particular output or an arrangement in the particular output of one or more fields of the plurality of fields corresponding to the input.

The one or more circuits can modify the neural network by determining a plurality of candidate outputs of the neural network responsive to applying the training data to the neural network, evaluating a condition indicative of differences between the plurality of candidate outputs and the plurality of sample responses, and modifying (e.g., updating one or more parameters of) the neural network according to the condition. The training data can include a plurality of queries that include the query, where individual queries can be assigned to at least one domain of a plurality of domains.

The one or more circuits can apply the training data to the neural network by applying a third query that includes the first query and a second query to the neural network. The query can be the first query, the plurality of fields corresponding to the query can be a plurality of first fields, and the plurality of sample responses corresponding to the query can be a plurality of first sample responses. The second query can be linked to the first query, and the training data can include a plurality of second fields corresponding to the second query and a plurality of second sample responses corresponding to the second query. The neural network can include at least one of (i) an autoregressive model or (ii) a model having an encoder and a decoder.

At least one aspect relates to a system. The system can include one or more processing units and one or more memory units storing instructions that, when executed by the one or more processing units, cause the one or more processing units to execute operations comprising applying, to a neural network, training data comprising a query, a plurality of fields corresponding to the query, and a plurality of sample responses corresponding to the query and the plurality of fields, the plurality of sample responses having variations relative to each other. The instructions can cause the one or more processing units to train the neural network, responsive to applying the training data, to generate, responsive to receiving (i) an input that relates to a domain of the training data and (ii) a plurality of fields corresponding to the input, a plurality of alternative outputs having variations relative to each other in syntax of incorporating one or more fields of the plurality of fields corresponding to the input.

The plurality of alternative outputs can include at least a first output having a first syntax and a second output having a second syntax that is varied from the first syntax. The syntax of a particular output of the plurality of outputs can represent at least one of a length of the particular output or an arrangement in the particular output of one or more fields of the plurality of fields corresponding to the input.

The instructions can cause the one or more processing units to modify the neural network by determining a plurality of candidate outputs of the neural network responsive to applying the training data to the neural network, evaluating a condition indicative of differences between the plurality of candidate outputs and the plurality of sample responses, and modifying the neural network according to the condition. The training data can include a plurality of queries that include the query. Each of the plurality of queries can be assigned to at least one domain of a plurality of domains.

The instructions can cause the one or more processing units to apply the training data to the neural network by applying a third query that includes the first query and a second query to the neural network. The query can be the first query, the plurality of fields corresponding to the query can be a plurality of first fields, and the plurality of sample responses corresponding to the query can be a plurality of first sample responses. The second query can be linked to the first query, and the training data can include a plurality of second fields corresponding to the second query and a plurality of second sample responses corresponding to the second query. The neural network can include at least one of (i) an autoregressive model or (ii) a model having an encoder and a decoder.

At least one aspect relates to a method. The method can include applying, by the one or more processors to a neural network, training data comprising a query, a plurality of fields corresponding to the query, and a plurality of sample responses corresponding to the query and the plurality of fields, the plurality of sample responses having variations relative to each other. The method can include training the neural network, by the one or more processors responsive to applying the training data, to generate, responsive to receiving (i) an input that relates to a domain of the training data and (ii) a plurality of fields corresponding to the input, a plurality of alternative outputs having variations relative to each other in syntax of incorporating one or more fields of the plurality of fields corresponding to the input. The plurality of alternative outputs can include at least a first output having a first syntax and a second output having a second syntax that is varied from the first syntax.

The syntax of a particular output of the plurality of outputs can represent at least one of a length of the particular output or an arrangement in the particular output of one or more fields of the plurality of fields corresponding to the input. The method can include modifying the neural network by determining a plurality of candidate outputs of the neural network responsive to applying the training data to the neural network, evaluating a condition indicative of differences between the plurality of candidate outputs and the plurality of sample responses, and modifying the neural network according to the condition. The training data can include a plurality of queries that include the query. Each of the plurality of queries can be assigned to at least one domain of a plurality of domains.

The method can include applying the training data to the neural network by applying a third query that includes the first query and the second query to the neural network. The query can be the first query, the plurality of fields corresponding to the query can be a plurality of first fields, and the plurality of sample responses corresponding to the query can be a plurality of first sample responses. The second query can be linked to the first query, and the training data can include a plurality of second fields corresponding to the second query and a plurality of second sample responses corresponding to the second query. The neural network can include at least one of (i) an autoregressive model or (ii) a model having an encoder and a decoder.

At least one aspect relates to a method. The method can include determining one or more responses to one or more queries based at least on an output of one or more neural networks, the output generated based at least on the neural network processing data representative of the one or more queries and data representative of one or more values corresponding to one or more fields associated with the one or more queries, the one or more neural networks trained to generate variational outputs from a same set of inputs.

The variational outputs can include at least a first output having a first syntax and a second output having a second syntax that is a variant of the first syntax. The method can include obtaining the one or more values using an application programming interface (API) corresponding to a domain associated with at least one query of the one or more queries.

The processors, systems, and/or methods described herein can be implemented by or included in at least one of a system associated with an autonomous or semi-autonomous machine (e.g., an in-vehicle infotainment system); a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for generating or presenting virtual reality (VR) content, augmented reality (AR) content, and/or mixed reality (MR) content; a system for performing conversational AI operations; a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for generating dialogue responses from structured data for conversational AI systems and applications are described in detail below with reference to the attached drawing figures, wherein:

FIG. 1 is a block diagram of an example computing environment for training and operating machine learning models.

FIG. 2 is a flow diagram of an example of a method of training a machine learning model to output natural language responses having varied syntax.

FIG. 3 is a flow diagram of an example of a method of using a machine learning model configured to output natural language responses having varied syntax.

FIG. 4 is a block diagram of an example content streaming system suitable for use in implementing some embodiments of the present disclosure;

FIG. 5 is a block diagram of an example computing device suitable for use in implementing some embodiments of the present disclosure; and

FIG. 6 is a block diagram of an example data center suitable for use in implementing some embodiments of the present disclosure.

### DETAILED DESCRIPTION

Systems and methods are disclosed related to using one or more machine learning models (alternatively referred to herein as “models”) to generate dialogue responses that are more conversational and varied than those generated using predefined template structure. The models described herein are more scalable and can provide a more natural user experience than conventional rules-based or template-based systems. The models can be trained and provided to a user system, and can be further trained based on runtime inputs received by the user system.

The model can be trained using a training data set that has annotated training data examples from multiple domains to enable the model to be responsive to queries from a variety of domains. For example, the model can be trained using training data from the Schema Guided Dialogue (SGD) dataset. Such training data sets can be beneficial by (1) including speech data (e.g., queries) from multiple domains and (2) including training data examples with query responses having variational sentence structures or other features for providing similar or identical information, which can facilitate training the model to generate more natural, varied responses to queries. The training data examples can be structured to indicate, as input, sample utterances (e.g., queries) and corresponding slot information, and sample responses (e.g., ground truth information, and/or example variances) as output.

The model can be based on a neural network, and can have features that allow the model to be trained to generate accurate but variational responses (e.g., to different instances of the same query or similar queries). For example, the model may include encoder and/or decoder components to facilitate more precise training, an auto-regressive decoder component to facilitate producing human-like outputs, a sequence to sequence model, such as a bidirectional and auto-regressive transformation (BART) or T5 model, and/or a generative pre-trained (GPT) based model.

For runtime operation, the system can include a dialogue manager that receives an utterance (e.g., user input, query), and identifies a domain (e.g., category, classification, area, topic) of the utterance and at least one dialog slot (e.g., field for data) of the utterance (e.g., for the utterance “what is the weather in Mountain View tomorrow,” the dialogue manager can process the utterance to identify the domain to be a weather domain and the dialog slots to include location and time). The dialogue manager can retrieve, from an application programming interface (API) corresponding to the domain, information to assign to fulfillment slots for a response (e.g., to retrieve location, time, temperature, etc., information from a weather API). The system can include a data processor that converts the information of the fulfillment slots to structured text, and a dataset generator that converts the structured text into an input for the trained model. For example, the trained model can receive, as input, an input vector or tensor representative of the structured text.

The model, responsive to receiving the input, can generate an output (e.g., a tensor or vector representative of speech data) representing a response to be presented responsive to the utterance or query. In embodiments, the system can include a post-processor to convert the output of the model into the response to be presented to the user (e.g., an answer to the question of “What is the weather in Mountain View tomorrow?”). As noted herein, because the model is trained using training data examples that have sample output responses with variational speech or sentence structure, the output that the model generates can similarly have variations to provide a more natural user experience. This can include generating output that more succinctly and/or precisely provides the information requested in the utterance, as compared with rules-based template response generators that may provide information from all slots for a template even where all the information may not be necessary to satisfy the information requested.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

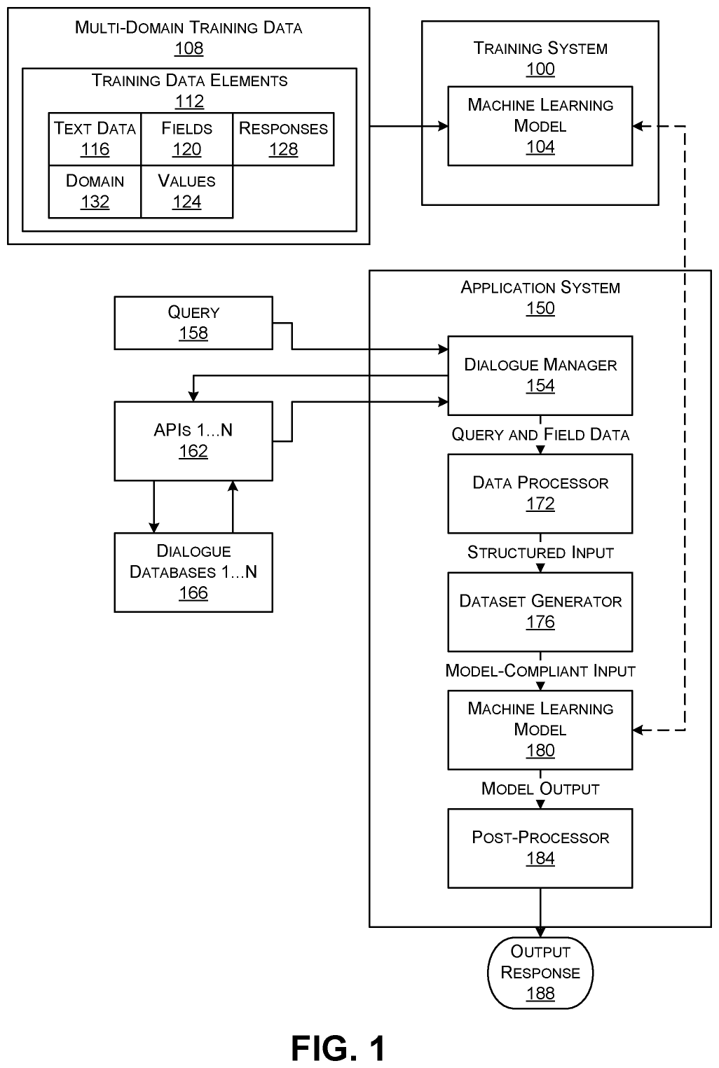

With reference to FIG. 1, FIG. 1 illustrates an example computing environment including a training system 100 and an application system 150 for training and deploying machine learning models, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The training system 100 can train or update one or more machine learning models 104. The machine learning model 104 may include one or more neural networks. The neural network can include an input layer, an output layer, and/or one or more intermediate layers, such as hidden layers, which can each have respective nodes. The training system 100 can train the neural network by modifying or updating one or more parameters, such as weights and/or biases, of various nodes of the neural network responsive to evaluating candidate outputs of the neural network.

The machine learning model 104 can be or include various neural network models, including models that are effective for operating on natural language data representations of various lengths. The machine learning model 104 can include one or more transformers, recurrent neural networks (RNNs), long short-term memory (LSTM) models, other network types, or various combinations thereof. The transformers can process relatively longer natural language data representations, such as an entire sentence rather than word-by-word, such as by using an attention mechanism to assign priority to and/or provide context to each component of the representation based on positions of the components. The RNNs can use internal state data to process inputs of various lengths, including natural language data representations, such as using outputs of nodes to affect subsequent inputs to those nodes. The LSTMs can have gating elements to facilitate retaining particular values of data in memory over various iterations of operation of the LSTMs.

The machine learning model 104 can include a sequence-to-sequence model, such as an autoregressive encoder model, and/or a model that includes an encoder to generate a latent representation (e.g., in an embedding space) of an input to the model (e.g., a representation of a different dimensionality than the input), and/or a decoder to generate an output representative of the input from the latent representation. The machine learning model 104 can include one or more bidirectional encoder representations from transformers (BERT) model, which can use context information from both directions connected to a layer for generating outputs from the layer. In some embodiments, the machine learning model 104 may include a large language model (LLM).

For example, the machine learning model 104 can include at least one bidirectional and auto-regressive transformer (BART) model. The machine learning model 104 can include a generative pre-trained transformer (GPT) model, which can be trained to predict subsequent components of a language dialogue (e.g., subsequent tokens) responsive to language dialogue inputs. For example, the machine learning model 104 can include a bidirectional encoder and an autoregressive decoder.

The training system 100 can train the machine learning model 104 using training data 108. Table 1, described in further detail below, provides examples of the training data 108. The training system 100 can access the training data 108 from one or more databases that may be maintained by the training system 100, maintained by systems separate from the training system 100, and/or maintained by entities other than the training system 100. The training data 108 can include data extracted from the Schema-Guided Dialogue (SGD) dataset and similar publicly available task-oriented dialog datasets. The training system 100 can pretrain the machine learning model 104 to train the machine learning model 104 to reconstruct at least a subset of the training data 108. The training system 100 can use a first subset of the training data 108 to train the machine learning model 104, and can use one or more second subsets of the training data 108 different than the first subset to test or validate the training of the machine learning model 104. The first subset and the one or more second subsets can correspond to the same domain or to different domains.

The training data 108 can include a plurality of training data elements 112 (e.g., training data instances). The training data elements can correspond to dialogues (e.g., conversations) that have been structured into training data elements. For example, the training data elements can represent portions of text (e.g., text data representing speech) from dialogues that are annotated to indicate particular features of the portions. The training data elements 112 can be structured data, such as by being arranged in a consistent format.

The training data element 112 can be a data structure that includes text data 116, at least one field 120 corresponding to the text data, at least one value 124 corresponding to each respective field, and at least one sample response 128 corresponding to the text data 116. The fields 120, values 124, and sample responses 128 can be linked to the text data 116 in the training database 108 to form the training data element 112.

The text data 116 can represent written and/or spoken/audio speech information, such as from dialogue of a person or generated by a computer system. The text data 116 can be at least a portion of the speech information, such as a syllable, word, sub-word, phrase, clause, sentence, character, or various more or less granular representations of the speech information. The text data 116 can represent an utterance, such as a statement or a query. For example, the text data 116 can represent a query requesting information, which may be in the form of a statement (e.g., “please tell me how long the drive to work is”) or question (e.g., “how long is my drive to work going to be?”).

The at least one field 120 can include one or more fields for information represented by the text data 116. For example, the fields 120 can be fields for information to respond to the query represented by the text data 116. The number of fields 120 corresponding to the text data 116 can depend at least on the information represented by the text data 116. The values 124 can be assigned to respective fields 120 and can represent the information to provide in response to the query represented by the text data 116. For example, where the text data 116 represents the query “How long is my drive to work going to be?,” the fields 120 can be for current location, home location, office location, length of time, and method of travel, and the respective values can indicate a current location (e.g., GPS coordinates), a location of a home (e.g., a predefined home location), a location of an office (e.g., a predefined office location), and the method of travel (e.g., by car).

The sample responses 128 can be responses identified from the dialogue that provide information in response to the query represented by the text data 116, such as to provide one or more values 124 of the fields 120 corresponding to the text data 116. Each training data element 112 can be arranged to have one or more sample responses 128 assigned to the corresponding text data 116. For example, a single sample response 128 can be assigned to the text data 116, or multiple sample responses 128 can be assigned to the same text data 116. For example, sample responses 128 to the query “How long is my drive to work going to be?” can be (i) “it will take you 20 minutes to get to work by driving,” (ii) “your drive is going to be 20 minutes long,” and (iii) “if you drive it will take you 20 minutes.” These sample responses 128 may be provided in a same training data element 112, or in multiple training data elements 112 each having text data 116 representing the query. Similarly, the training data 108 can be structured so that varied text data 116 can have the same or similar sample responses 128—for example, a query “How long will it take me to get to work?” can be included in the same training data element 112 as the query “How long is my drive to work going to be?,” or in a different training data element 112, and one or more of the responses 128 of (i) “it will take you 20 minutes to get to work by driving,” (ii) “your drive is going to be 20 minutes long,” and (iii) “if you drive it will take you 20 minutes” can be included in the same or different training data elements 112 as each other. Various such structures of the training data 108 can facilitate more efficient retrieval of and training using the training data 108.

The sample responses 128 can be variational (e.g., variants of one another). For example, the sample responses 128 can have variations with respect to how they arrange information of the values 124, including whether each particular value 124 is included in the sample response 128 and where each particular value 124 is provided in the sample response 128. The sample responses 128 can be variational by having variations of syntax (e.g., length; whether particular values 124 are included or not included in the sample responses 128; arrangement of words or phrases; arrangements of words or other morphological elements to form phrases and/or sentences). For example, the three example sample responses 128 provided above each provide the information of a length of time of 20 minutes (e.g., the value 124 of the length of time field 120), while arranging the information in different positions in the sample responses 128 with variations in other words included in the sample responses 128 as well. By training the machine learning model 104 using sample responses 128 that have variations, the machine learning model 104 can in turn generate runtime responses (e.g., output responses 188 described further herein) that similarly have variations to provide a more natural user experience. The machine learning model 104 can be trained using sample responses 128 that have syntax variations including more or less succinctly providing information in response to similar queries; for example, while the queries “what is the weather?” and “what is the temperature?” both relate to the weather domain, the machine learning model 104 can be trained using training data 108 that includes the sample response 128 “the weather will be sunny with a high of 60 degrees and a low of 40 degrees” linked with text data 116 for “what is the weather?” and the sample response 128 “the temperature is currently 50 degrees” linked with text data 116 for “what is the temperature?,” facilitating training the machine learning model 104 to be capable of generating runtime responses having succinct syntax variations as appropriate to the syntax of the query.

The training data 108 can correspond to multiple domains. For example, each training data element 112 can be assigned (e.g., labeled with or annotated with) a respective domain 132. The domains 136 can represent predetermined categories of information associated with the text data 116 of the training data element 112. For example, the domains 136 can include weather, navigation, banking, reservations, or various other domains of dialogues and information that may be useful for training the machine learning model 104. By training the machine learning model 104 using training data 108 of multiple domains 136, the training system 100 can make the machine learning model 104 more flexible and scalable with respect to handling queries from varied domains; the machine learning model 104 can be further trained with training data (which may be domain-specific) that may be useful for the application system 150, such as to provide particular services.

Table 1 below provides an example of training data elements 112 of training data for a weather domain and a banking domain. As shown in Table 1, each query, represented by text data 116, can be linked with related fields 120, values 124 of the fields 120, and sample responses 128 corresponding to the query; the training data elements 112 can also include annotations of respective domains 136, such that the training data elements 112 and the queries thereof may be assigned to respective domains 136. As shown, with respect to the first query in Table 1, the corresponding responses 128 to the query can have variations of what information from values 124 of fields 120 is included in the sample responses 128 and/or the syntax of the information. For example, the first sample response 128 includes the values 124 for max temp, condition, and location, while the second sample response 128 includes the values 124 for max temp, min temp, condition, and location; these sample responses 128 thus include the same values 124 for the information for max temp, condition, and location, yet with varied syntax.

TABLE 1

| | | | Sample Responses |
|---|---|---|---|
| | Fields(1) | Value(Field(1)) | 1(a) . . . 1(n) |
| Domain1: Query(1) | | | |
| “What is the weather in | Min Temp | 44 | “The weather today in |
| Mountain View today?” | Max Temp | 65 | Mountain View will be |
| | | | sunny with a high of 65 |
| | | | degrees” |
| | Humidity Percentage | 34 | . . . |
| | Condition | Sunny | |
| | Wind Speed | 12 | “It will be sunny today |
| | Location | Mountain View | in Mountain View, with |
| | | | temperatures ranging |
| | | | from a low of 44 |
| | | | degrees to a high of 65 |
| | | | degrees” |
| Domain1: Query(2) | | | |
| “What's the weather | Min Temp | 44 | “The weather today will |
| today?” | Max Temp | 65 | be sunny with a high of |
| | | | 65 degrees” |
| | Humidity Percentage | 34 | . . . |
| | Condition | Sunny | |
| | Wind Speed | 12 | “It will be sunny today, |
| | Location | Mountain View | with temperatures |
| | | | ranging from a low of |
| | | | 44 degrees to a high of |
| | | | 65 degrees” |
| Domain2: Query(1) | | | |
| “What's my account | Account Label | Checking | “The balance in your |
| balance?” | Account Value | $1000 | checking account is |
| | | | $1000.” |
| | Contact Name | John Smith | . . . |
| | | | “You have a balance of |
| | | | $1000 in your checking |
| | | | account.” |
| Domain2: Query(2) | | | |
| “How much money do I | Account Label | Checking | “Your checking |
| have in my checking | Account Value | $1000 | account's balance is |
| account?” | | | $1000.” |
| | Contact Name | John Smith | . . . |
| | | | “You have $1000 in |
| | | | your checking account.” |

The machine learning model 104 can be trained by applying the training data 108 as input to the machine learning model 104, such as to an input layer of a neural network of the machine learning model 104. The training system 100 can structure the training data 108 into a format compatible with the input layer, such as to have the text data 116, values 124, and sample responses 128 organized in a consistent format.

The training system 100 can provide at least some of the training data 108 to the machine learning model 104 to have multiple utterances from a dialogue. For example, the training system 100 can provide training data 108 that includes at least a first query and a second query. The first query and second query can be utterances from a same dialogue, such as from the same or different speakers in a dialogue. The first query and the second query can be assigned to different domains; for example, the first query can be for a restaurant search domain, and the second query can be for a reservation request domain. The training data 108 can include values 124 of fields 120 corresponding to each of the first and second queries, as well as samples responses 128 corresponding to each of the first and second queries. The training system 100 can apply, as input to the machine learning model 104, training data 108 that has a third query incorporating the first query and the second query. For example, the training system 100 can apply training data 108 that includes a training data element 112 having a third query (as text data 116 representing a first query and a second query) and having values 124 of fields 120, sample responses 128, and assignments of domain(s) 132 corresponding to each of the respective first query and second query. The training data element 112 of the third query can correspond to a multi-turn input, such as a dialogue having multiple utterances, a concatenation of multiple queries to form the text data 116 of the training data element 112 of the third query (along with linking of the values 124, sample responses 128, and domains 132 of the multiple queries), or various combinations thereof. As such, the training system 100 can train the machine learning model 104 to be capable of receiving multi-turn inputs, including inputs from varied domains, to more effectively handle varied conversations/exchanges/interactions with users.

Responsive to receiving the training data 108, the machine learning model 104 can generate at least one candidate output. The at least one candidate output can be an estimated response, such as a response that is an estimate of a target response meeting criteria to which the machine learning model 104 is trained or configured, such as to meet criteria relating to at least one of accuracy of generating responses having the same information as the sample responses 128 or variational syntax relative to the sample responses 128. The candidate outputs can be used to evaluate whether the machine learning model 104 has been trained sufficiently to satisfy a target performance metric, such as a metric indicative of accuracy of the machine learning model 104 in generating outputs, such as outputs that are sufficiently similar to the sample responses 128.

For example, the training system 100 can use a function, such as a loss function or an optimization function, to evaluate a condition for determining whether the machine learning model 104 is configured (sufficiently) to meet the target performance metric. The condition can be a convergence condition, such as a condition that is satisfied responsive to factors such as an output of the function meeting the target performance metric, a number of training iterations, training of the machine learning model 104 converging, or various combinations thereof. The condition can be a function indicating differences between the candidate outputs and the sample responses 128 corresponding to the inputs (e.g., text data 116 and values 124) used to generate the candidate outputs.

For example, the training system 100 can identify, for each candidate output, the sample response 128 of the training data element 112 used to generate the candidate output. The training system 100 can operate or cause the function to compare each candidate output with the respective identified sample response 128, and determine a function score (e.g., loss score, cost score, and/or optimization score) based at least on the comparisons. For example, the function can be of the form of a mean error, mean squared error, or mean absolute error function.

The training system 100 can iteratively apply training data 108 (or at least a subset thereof) to the machine learning model 104, evaluate the function responsive to applying the training data 108, and modify (e.g., update one or more weights and biases of) the machine learning model 104. The training system 100 can modify the machine learning model 104 by modifying at least one of a weight or a parameter of the machine learning model 104. The training system 100 can evaluate the function by comparing an output of the function to a threshold of a convergence condition, such as a minimum or minimized cost threshold, such that the machine learning model 104 is determined to be sufficiently trained (e.g., sufficiently accurate in generating outputs) responsive to the output of the function being less than the threshold. The training system 100 can output the machine learning model 104 responsive to the convergence condition being satisfied.

The training system 100 can train the machine learning model 104 using one or more functions that are configured to value generation of candidate outputs that are variational in syntax relative to each other and/or relative to the sample responses 128. For example, the training system 100 can use a function that assigns scores to the candidate outputs based on (i) a response metric and (ii) one or more variation metrics. The response metric can indicate an accuracy in responding to the query represented by the input of the training data element 116 used to generate the candidate output; for example, the training system 100 can determine the response metric according to matching values represented in the candidate output with values represented in the sample response 128. The variation metric(s) can include a metric indicating variations in syntax between the candidate outputs and the sample responses 128 (e.g., to value, together with the response metric, candidate outputs that both accurately capture information represented in the sample responses 128 and have variations in syntax relative to the corresponding sample responses 128). The variation metric(s) can include a metric indicative of variations in syntax of the candidate outputs (e.g., the training system 100 can identify candidate outputs expected to present similar information, such as based on being generated responsive to the same or similar inputs, and can compare syntax of the candidate outputs with each other).

Referring further to FIG. 1, an application system 150 can operate or deploy a machine learning model 180 to generate responses to queries 158. The application system 150 can be a system to provide natural language services, such as chatbots, digital avatars, speech recognition systems, and/or the like. The application system 150 can be a system that provides services for a particular domain or domains, which may or may not correspond to the domains of the training data 108 used to train the machine learning model 104. The application system 150 can be implemented by or communicatively coupled with the training system 100, or can be separate from the training system 100.

The machine learning model 180 can be or be received as the machine learning model 104 or a representation thereof. For example, a data structure representing the machine learning model 104 can be used by the application system 150 as the machine learning model 180; the data structure can represent parameters of the trained machine learning model 104, such as weights or biases used to configure the machine learning model 180 based on the training of the machine learning model 104.

The machine learning model 180 can be a further trained instance of the machine learning model 104. For example, the machine learning model 180 can be trained using data representative of dialogue information, such as training data 108, data from databases 166, or various subsets or combinations thereof.

The application system 150 can include a dialogue manager 154. The dialogue manager 154 can be or include any function, operation, routine, logic, or instructions to perform functions such as processing queries 158 to generate input data for use by the machine learning model 180.

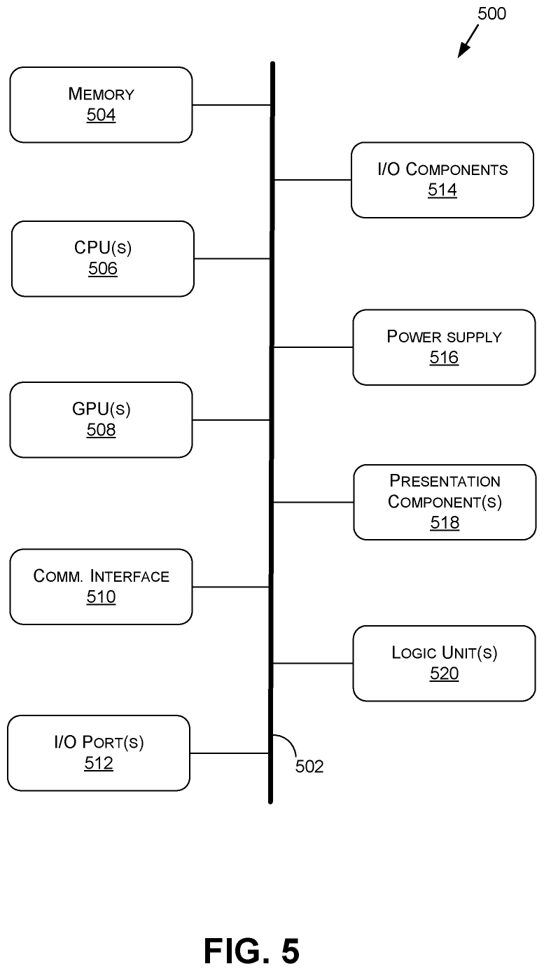

For example, the dialogue manager 154 can receive at least one query 158. The dialogue manager 154 can receive the query 158 from I/O components 514 described with reference to FIG. 5. For example, the dialogue manager 154 can receive the query 158 from a natural user interface, such as a speech recognition or chatbot interface, implemented using the I/O components 514 and/or the communication interface 210. The dialogue manager 154 can include one or more of various speech detection components such as speech-to-text processors, dictionaries, language models, voice recognition components, or combinations thereof to detect data (e.g., text or speech data) that the query 158 represents.

The query 158 can include data representative of text or speech. For example, the dialogue manager 154 (or the I/O components 514) can detect the query 158 as a text string, such as a text string having one or more morphological elements (e.g., words, phrases). The query 158 can indicate a statement or question, and can be a single or initial query in a dialogue, or part of a multi-turn dialogue. The query 158 can be received as multiple statements and/or questions.

The dialogue manager 154 can identify a domain of the query 158. For example, the dialogue manager 154 can use one or more rules, heuristics, models, databases, or various combinations thereof to identify the domain. As an example, the dialogue manager 154 can identify one or more keywords of the query 158 (e.g., keywords corresponding to one or more words of the query 158), and perform a lookup in a domain table mapping keywords with domains to identify the domain. The dialogue manager 154 can apply the one or more keywords as input to a domain detection model trained to output a domain based on training data annotated with domain labels (which may be similar or identical to training data 108).

The dialogue manager 154 can provide a request for dialogue data to retrieve from one or more dialogue databases 166 using one or more application programming interfaces (APIs) 162. The APIs 162 can be provided by systems that operate the dialogue databases 166. For example, each dialogue database 166 can be coupled with a respective API 162 that provides access to data of the dialogue database 166 responsive to the request. The dialogue manager 154 can generate the request to include the domain of the query 158. The dialogue manager 154 can generate the request to include one or more fields (e.g., slots) for data to be requested from the dialogue database 166 corresponding to the domain of the query 158. For example, the dialogue manager 154 can select a particular API 162 of the APIs 162 according to the domain of the query 158, and can provide the request to the API 162 to request data corresponding to fields that the dialogue manager 154 identifies from the query 158. As an example, responsive to receiving the query 158 “How is the weather in Mountain View tomorrow?,” the dialogue manager 154 can identify the domain of the query 158 to be weather, select an API 162 linked with a particular dialogue database 166 having weather data, and can generate the request to the selected API 162 to request data for fields for a forecast time (tomorrow), a location (Mountain View), a temperature maximum, a temperature minimum, and a weather condition. The dialogue manager 154 can identify multiple domains from the query 158, and can transmit requests to multiple APIs 162 corresponding to the multiple domains sequentially, simultaneously, or in other orders.

The dialogue manager 154 can receive a response from the dialogue database 166, via the API 162, that includes values of the fields indicated in the request to the API 162 as retrieved from the dialogue database 166 by the API 162. The dialogue manager 154 can provide the query 158 and the values of the fields received from the dialogue database 166 to a data processor 172. The dialogue manager 154 can provide the query 158 and the values of the field in a particular format, such as a raw text format (e.g., text, json, or yami file).

The data processor 172 can be or include any function, operation, routine, logic, or instructions to perform functions such as processing the information received from the dialogue manager 154 (e.g., the query 158 and values of the field) to generate a structured input, such as a structured text data structure. The structured text data structure can be a data structure in which the raw text of the information received from the dialogue manager 154 is assigned to particular fields. For example, the query 158 can be assigned to a query field, and each value of the respective fields can be assigned to corresponding value fields. The data processor 172 can provide the structured input to a dataset generator 176.

The dataset generator 176 can be or include any function, operation, routine, logic, or instructions to perform functions such as generating, based at least on the structured input, an input compliant with the machine learning model 180. For example, the machine learning model 180 can be structured to receive input in a particular format, such as a numeric format, which may be expected to include numerical (e.g., rather than text string) values. The particular format can be analogous to a format by which the training data 108 is applied to the machine learning model 104 to train the machine learning model 104. The dataset generator 176 can identify the particular format of the machine learning model 180, and can convert the structured input to the particular format. For example, the dataset generator 176 can convert the structured input to a vector or tensor.

The dialogue manager 154, data processor 172, and/or dataset generator 176 can be implemented as discrete functions or in an integrated function. For example, a single functional module can receive the query 158 and can generate the input to provide to the machine learning model 180 responsive to receiving the query 158.

Referring further to FIG. 1, the machine learning model 180 can generate a model output responsive to receiving the input (e.g., responsive to receiving the input from the dataset generator 176). As noted above, the input can relate to a domain of at least one of the training data 108 or the dialogue databases 166; for example, the query 158 can indicate a request for information related to a domain represented by the training data 108 or the dialogue databases 166. The input can indicate a plurality of values of fields retrieved from the dialogue databases 166 corresponding to the input, such as fields having values to provide information responsive to the query 158. The model output can represent a response to the query 158.

The machine learning model 180, by being based at least on the trained machine learning model 104, can be capable of generating alternative model outputs (e.g., responsive to receiving similar or identical inputs at various instances). The machine learning model 180 can generate outputs that are alternatives (e.g., variational) by having variations of syntax relative to each other. The syntax of each model output can represent at least one of a length of the model output, an order in which words of the model output that represent the values of the fields of the input are incorporated (e.g., positioned) in the model output, or whether a particular value is incorporated (e.g., included) in the model output. The length can be, for example, a number of characters, syllables, or words of the model output. The order can be a relative or absolute order of values represented by the model output; for example, the machine learning model 180 can generate alternative model outputs that have a same length by having a same number of words, and variational syntax by positioning two particular values in different relative (e.g., relative to each other) or absolute (e.g., relative to a beginning or end position) positions in the model output. For example, responsive to input representing a query 158 such as “What is the weather in Mountain View?,” the machine learning model 180 can generate alternative model outputs such as “it will be sunny and warm in Mountain View,” “the weather is sunny with a high of 65 degrees,” and “Mountain View will have warm sunny weather with a high of 65 degrees.” Each of these model outputs are variational in syntax based on features such as whether or not the high temperature is included in the model output, the length of the model outputs, and the relative positioning of values such as “Mountain View,” “sunny” and “warm.” As such, each of these model outputs can have different syntaxes that are variants of each other. For example, the machine learning model 180 can generate a first output responsive to receiving an input at a first instance and a second output having a different syntax than the first output responsive to receiving the same input at a second instance. For example, responsive to receiving a test input at a first instance and at a second instance, the machine learning model 104 can generate a first output and a second output, the second output satisfying a criteria for a difference in syntax relative to the first output; the criteria can be a threshold value for a difference in syntax, which can be determined based on the various aspects of syntax (e.g., length, order, inclusion/exclusion of particular values).

The query 158 can have multiple utterances. For example, the dialogue manager 154 can identify multiple queries 158 and retrieve values for fields from the dialogue databases 166 using the APIs 162 for each of the multiple queries 158. The dialogue manager 154 can receive a first query 158 and a second query 158, and can combine the first and second queries 158, such as by concatenating the first and second queries 158, to generate a third query 158 that includes the first query 158 and the second query 158, and can retrieve the values for the fields corresponding to the first query 158 the second query 158 to associate with the third query 158. The dialogue manager 154 can provide the third query 158 and the values retrieved from the dialogue databases 166 for input to the machine learning model 180. The dialogue manager 154 can receive the first query 158 at a first instance, may provide input based at least on the first query 158 to the machine learning model 180 to cause the machine learning model 180 to generate a first output, can receive the second query 158 at a second instance, and can provide input based at least on the third query 158 (e.g., provide input based at least on the first query 158 and the second query 158) to the machine learning model 180 to generate a second output, which may be a later response in a conversation corresponding to the queries 158. As such, the machine learning model 180 can use the information from earlier portions of conversations to more accurately generate later responses, including for multi-turn conversations that may relate to multiple domains.

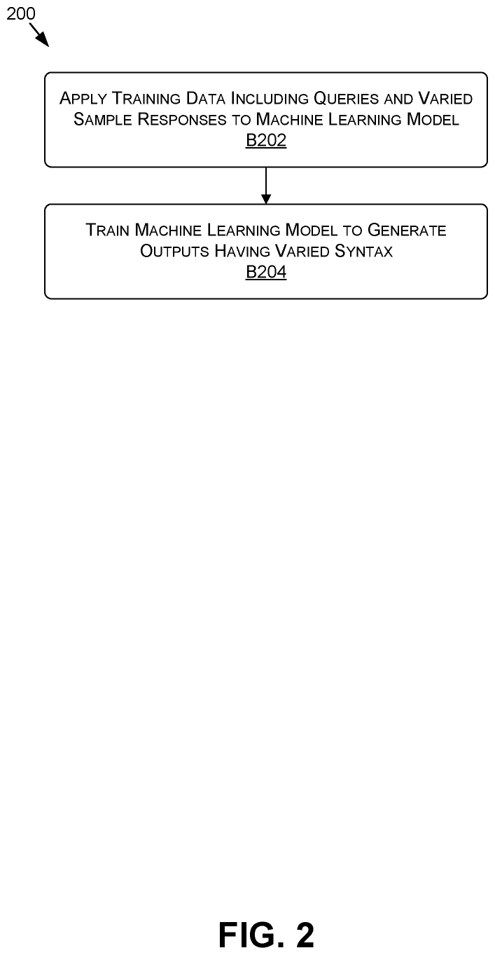

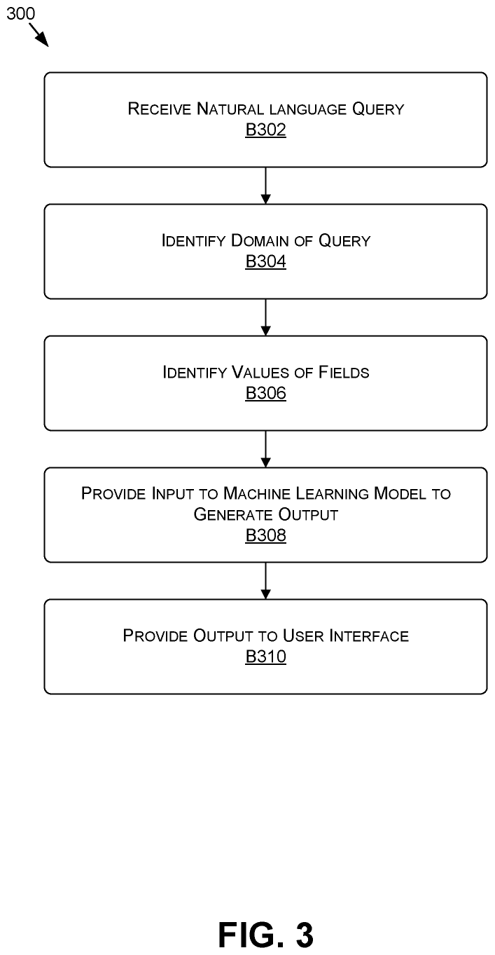

Now referring to FIGS. 2-3, each block of methods 200 and 300, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 200 and 300 are described, by way of example, with respect to the system of FIG. 1. However, these methods may additionally or alternatively be executed by any one system, or any combination of systems, including, but not limited to, those described herein.

With reference to FIG. 2, FIG. 2 is a flow diagram showing a method 200 for training a machine learning model to generate outputs having variations in syntax, in accordance with some embodiments of the present disclosure. The method 200, at block B202, includes applying training data to a machine learning model. The training data can include a query, a plurality of fields corresponding to the query, and/or a plurality of sample responses corresponding to the query and the plurality of fields. The query can be an utterance, such as an utterance representing a statement or question requesting information and/or a further response from the neural network. The query can have a domain assigned to or otherwise associated with the query. The plurality of fields can be slots for values indicating information corresponding to the query. The plurality of sample responses can have variations relative to each other, such as variations in syntax (e.g., variations in length, arrangement of inclusion of values or other components of the sample responses, inclusion or exclusion of various values, or combinations thereof). The training data can include multiple concatenated queries (e.g., multiple utterances of a multi-turn dialogue) along with corresponding values of fields and sample responses. The machine learning model can include a neural network, such as by including at least one of an autoregressive model or a model having an encoder and a decoder, such as a BART model or a GPT model. In some embodiments, the machine learning model may include a large language model (LLM).

The training data can be applied to the neural network as part of a pretraining process. For example, the training data can be multi-domain data maintained by one or more first systems to facilitate training the neural network by the one or more first systems or a second system, and provide the trained neural network to a third system. Applying the training data can include applying a subset of the training data, such as a subset associated with one or more particular domains selected for training the machine learning model. The applied training data can include a single query (and corresponding values and sample response(s)) or a plurality of concatenated queries (and corresponding values and sample responses).

The method 200, at block B204, includes training the machine learning model to generate outputs having variations of syntax relative to each other. The machine learning model can be trained by evaluating one or more candidate outputs of the machine learning model relative to the sample responses of the training data to determine whether the one or more candidate outputs satisfy one or more conditions or criteria, and modifying the machine learning model responsive to the one or more candidate outputs not satisfying the one or more conditions or criteria (or outputting the machine learning model responsive to the one or more candidate outputs satisfying the one or more conditions). Training the machine learning model can include iteratively applying the training data (which may be the same training data or different subsets of the training data for each iteration) to the machine learning model to cause the machine learning to generate candidate outputs for evaluation.

The evaluation of the machine learning model or the candidate outputs thereof can include using one or more functions, such as loss functions or optimization functions, to compare the candidate outputs with the sample responses and/or with each other. For example, loss functions can be operated or applied that determine various differences between the candidate outputs and the sample responses. The training of the machine learning model can include modifying parameters of the machine learning model, such as by modifying weights and/or biases of components of the machine learning model, such as weights and/or biases of nodes of layers of the machine learning model. The machine learning model can be trained iteratively, such as by modifying the weights and/or biases responsive to evaluation of each iteration of generating candidate outputs and evaluating the function(s) according to the candidate outputs. The machine learning model can be trained using functions that assign value to variations in syntax, such as to assign relatively higher values to candidate outputs that have variations in syntax relative to the sample responses and/or relative to each other.

Training the machine learning model can include training the machine learning model with batches of training data at various instances. For example, a first batch of training data (e.g., from databases having training data of one or more first domains, such as language model training data) can be used to pretrain the machine learning model using one or more first systems. A second batch of training data, such as runtime inputs or runtime dialogues managed by one or more second systems, can be used to train (e.g., further train) the model using the one or more second systems.

The trained machine learning model can be output in various formats. For example, the trained machine learning model can be output as a data structure representing structure (e.g., nodes, layers, and arrangements thereof) of the machine learning model and/or parameters (e.g., weights, biases assigned to particular nodes or other components of the machine learning model) representing the configuration of the machine learning model as a trained machine learning model. The trained machine learning model can be output as the parameters (e.g., with less or no data representing the structure of the machine learning model), such as to allow a separate system from the system that trained the machine learning model to efficiently be configured in accordance with the training.

Now referring to FIG. 3, FIG. 3 is a flow diagram showing a method 300 for using a machine learning model to generate outputs that can have variations in syntax, in accordance with some embodiments of the present disclosure. The method 300, at block B302, includes receiving a query, such as a natural language query. The query can be an utterance, such as a statement or question. The query can be received directly or indirectly from a user interface, such as a speech or text interface that receives a text or audio signal representative of the query and generates speech data indicating the query. The query can be received as multiple queries, such as a first query received at a first instance and a second query received at a second instance. The query can be received at various instances during a dialogue with a user performed via the user interface.

The method 300, at block B304, can include identifying at least one domain of the query. The domain can be identified by performing any of various text recognition operations on the query, such as to identify keywords of the query corresponding to domains. The domain can be identified by applying the keywords as input to a data structure—such as (but without limitation) a domain lookup table—to retrieve the domain. The query can include multiple queries, from which multiple domains can be identified.

The method 300, at block B306, can include identifying values of fields representing information for responding to the query. The values can be identified from dialogue databases corresponding to various domains, such as by transmitting a request indicating the fields and the identified domain to one or more APIs linked with the dialogue databases. The fields can be identified by performing any of various text recognition operations on the query. The values can be identified responsive to receiving each query, in a batch responsive to receiving multiple queries.

The method 300, at block B308, can include providing input (e.g., runtime input) that includes the query and the values of the fields to a machine learning model. The input can be provided in a format compatible with the machine learning model, such as a numerical input corresponding to a structure of an input layer of the machine learning model.

The machine learning model can generate an output responsive to receiving the input. The output can have particular characteristics to provide a more natural user experience with the output. For example, the machine learning model can be trained to be capable of generating outputs to the same or similar inputs that have variations in syntax, including to more concisely, verbosely, and/or accurately incorporate a particular subset of the values of the fields in the output.

The method 300, at block B310, can include providing the output to the user interface. For example, the output can be converted into a text string and/or speech data, which can be presented or rendered by display or audio.

### Example Content Streaming System

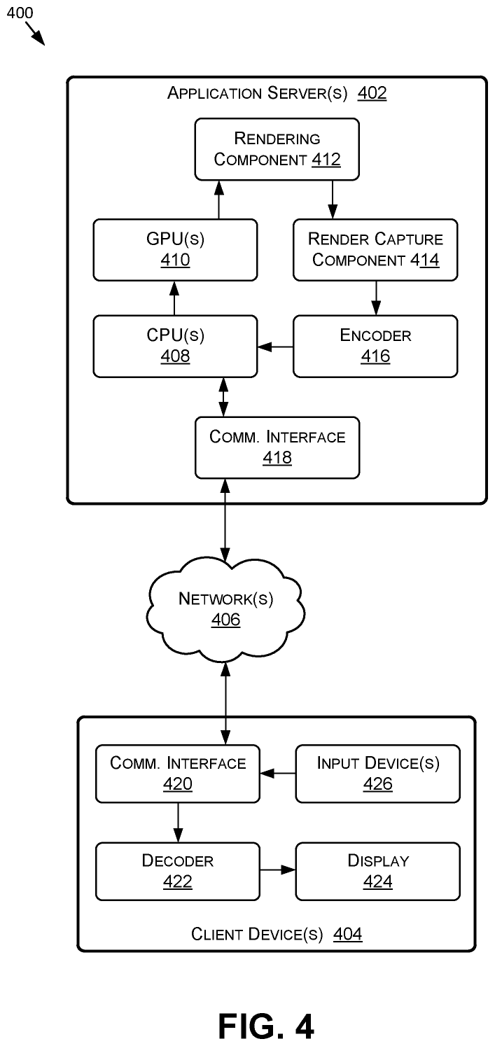

Now referring to FIG. 4, FIG. 4 is an example system diagram for a content streaming system 400, in accordance with some embodiments of the present disclosure. FIG. 4 includes application server(s) 402 (which may include similar components, features, and/or functionality to the example computing device 500 of FIG. 5), client device(s) 404 (which may include similar components, features, and/or functionality to the example computing device 500 of FIG. 5), and network(s) 406 (which may be similar to the network(s) described herein). In some embodiments of the present disclosure, the system 400 may be implemented, including for training machine learning models to manage natural conversational experiences by being capable of generating outputs having variational syntax, and operating the machine learning models in a runtime setting to provide natural conversational experiences to a user. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types.

In the system 400, for an application session, the client device(s) 404 may only receive input data in response to inputs to the input device(s), transmit the input data to the application server(s) 402, receive encoded display data from the application server(s) 402, and display the display data on the display 424. As such, the more computationally intense computing and processing is offloaded to the application server(s) 402 (e.g., rendering—in particular ray or path tracing—for graphical output of the application session is executed by the GPU(s) of the game server(s) 402). In other words, the application session is streamed to the client device(s) 404 from the application server(s) 402, thereby reducing the requirements of the client device(s) 404 for graphics processing and rendering.

For example, with respect to an instantiation of an application session, a client device 404 may be displaying a frame of the application session on the display 424 based on receiving the display data from the application server(s) 402. The client device 404 may receive an input to one of the input device(s) and generate input data in response, such as input data indicative of a query for information requested via a chatbot or other conversational interface. The client device 404 may transmit the input data to the application server(s) 402 via the communication interface 420 and over the network(s) 406 (e.g., the Internet), and the application server(s) 402 may receive the input data via the communication interface 418. The CPU(s) may receive the input data, process the input data, and transmit data to the GPU(s) that causes the GPU(s) to generate a rendering of the application session. For example, the input data may be representative of a movement of a character of the user in a game session of a game application, firing a weapon, reloading, passing a ball, turning a vehicle, etc. The rendering component 412 may render the application session (e.g., representative of the result of the input data) and the render capture component 414 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 402. In some embodiments, one or more virtual machines (VMs)—e.g., including one or more virtual components, such as vGPUs, vCPUs, etc.—may be used by the application server(s) 402 to support the application sessions. The encoder 416 may then encode the display data to generate encoded display data and the encoded display data may be transmitted to the client device 404 over the network(s) 406 via the communication interface 418. The client device 404 may receive the encoded display data via the communication interface 420 and the decoder 422 may decode the encoded display data to generate the display data. The client device 404 may then display the display data via the display 424.

### Example Computing Device

FIG. 5 is a block diagram of an example computing device(s) 500 suitable for use in implementing some embodiments of the present disclosure. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one embodiment, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some embodiments, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). In other words, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an ×86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In embodiments, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In embodiments, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In embodiments, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that enable the computing device 500 to communicate with other computing devices via an electronic communication network, included wired and/or wireless communications. The communication interface 510 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may enable the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user, such as to receive from and output to a user speech data, including queries and responses to queries. In some instances, inputs may be transmitted to an appropriate network element for further processing, such as to generate responses to queries to facilitate providing the natural user interface. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that enable detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to enable the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

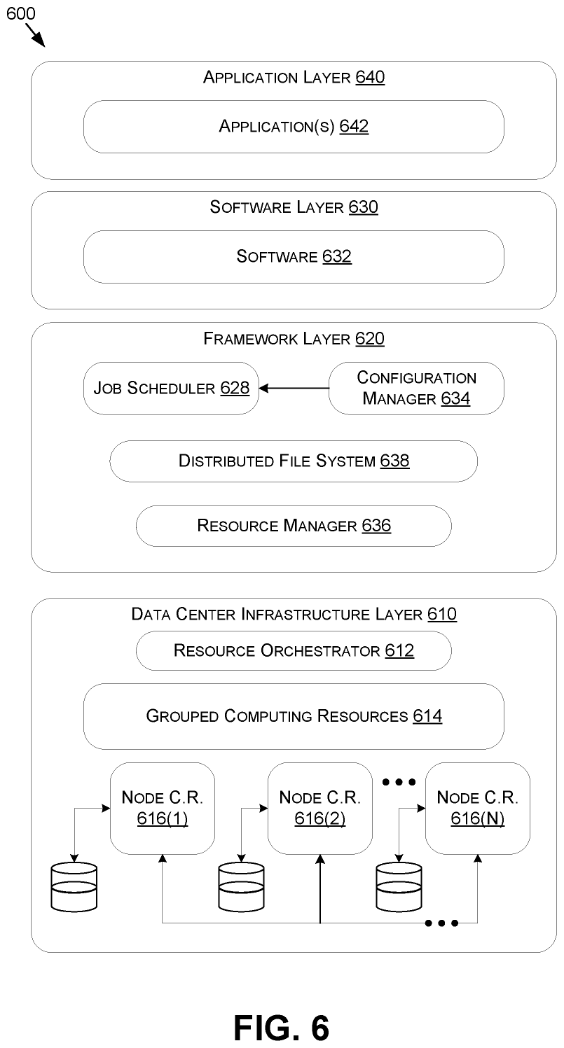

FIG. 6 illustrates an example data center 600 that may be used in at least one embodiments of the present disclosure, such as to implement the training system 100 or the application system 150 in one or more examples of the data center 600. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one embodiment, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 616(1)-616(N) may correspond to a server having one or more of the above-mentioned computing resources. In addition, in some embodiments, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one embodiment, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one embodiment, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one embodiment, resource orchestrator 612 may include a software design infrastructure (SDI) management entity for the data center 600. The resource orchestrator 612 may include hardware, software, or some combination thereof.

In at least one embodiment, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may utilize distributed file system 638 for large-scale data processing (e.g., “big data”). In at least one embodiment, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one embodiment, clustered or grouped computing resources may include grouped computing resource 614 at data center infrastructure layer 610. The resource manager 636 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to perform training of the machine learning model 104 and/or operation of the machine learning model 180.

In at least one embodiment, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models (e.g., train the machine learning model 104) or predict or infer information using one or more machine learning models (e.g., the machine learning model 180) according to one or more embodiments described herein. For example, a machine learning model(s) may be trained by calculating weight parameters according to a neural network architecture using software and/or computing resources described above with respect to the data center 600. In at least one embodiment, trained or deployed machine learning models corresponding to one or more neural networks may be used to infer or predict information using resources described above with respect to the data center 600 by using weight parameters calculated through one or more training techniques, such as but not limited to those described herein.

In at least one embodiment, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
determine, responsive to receiving a query, one or more values for one or more fields corresponding to a domain associated with the query;
generate, using a neural network and based at least on the query and the one or more values, a response; and
cause, using at least one of a display or an audio speaker device, a presentation of the response.

2. The processor of claim 1, wherein the one or more values are determined based at least on accessing one or more application programming interfaces (APIs) associated with the domain.

3. The processor of claim 1, wherein the neural network is updated using ground truth data representative of variational responses to a same set of input data, the same set of input data including one or more training queries and one or more training values corresponding to one or more training fields.

4. The processor of claim 1, wherein the neural network is updated using training data including a plurality of queries associated with a plurality of domains.

5. The processor of claim 1, wherein:
the query is a first query and the plurality of fields corresponding to the query are a plurality of first fields; and
the response is further generated based at least on a second query linked to the first query, and one or more values corresponding to one or more second fields corresponding to the second query.

6. The processor of claim 1, wherein the neural network comprises at least one of (i) an autoregressive model or (ii) a model having an encoder and a decoder.

7. The processor of claim 1, wherein the neural network includes a large language model (LLM).

8. The processor of claim 1, wherein the neural network is pre-trained on a plurality of domains prior to being re-trained for a particular domain included in the plurality of domains or separate from the plurality of domains.

9. The processor of claim 1, wherein the processor is comprised in at least one of:
a system of an autonomous or semi-autonomous machine;
an in-vehicle infotainment system of an autonomous or semi-autonomous machine;
a system for performing simulation operations;
a system for performing digital twin operations;
a system for performing light transport simulation;
a system for performing collaborative content creation for 3D assets;
a system for generating or presenting one or more of virtual reality content, augmented reality content, or mixed reality content;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

10. A method comprising:
determining one or more responses to one or more queries based at least on an output of one or more neural networks, the output generated based at least on the neural network processing data representative of the one or more queries and data representative of one or more values corresponding to one or more fields associated with the one or more queries, the one or more neural networks trained to generate variational outputs from a same set of inputs.

11. The method of claim 10, wherein the variational outputs include at least a first output having a first syntax and a second output having a second syntax that is a variant of the first syntax.

12. The method of claim 10, further comprising obtaining the one or more values using an application programming interface (API) corresponding to a domain associated with at least one query of the one or more queries.

13. A processor comprising:
one more circuits to:
determine, using a neural network and based at least on processing a training data instance including a query and values corresponding to a plurality of fields corresponding to the query, a plurality of estimated responses; and
update one or more parameters of the neural network based at least on comparing the plurality of estimated responses to a plurality of variational sample responses corresponding to the query and the values.

14. The processor of claim 13, wherein the plurality of estimated responses include at least a first estimated response having a first syntax and a second estimated response having a second syntax that is a variant of the first syntax.

15. The processor of claim 13, wherein a syntax of a particular estimated response of the plurality of estimated responses represents at least one of a length of the particular estimated response or an arrangement of one or more values of the values corresponding to the input in the particular estimated response.

16. The processor of claim 13, wherein the comparing includes evaluating a condition indicative of one or more differences between the plurality of estimated responses and the plurality of sample responses.

17. The processor of claim 13, wherein a training data set including the training data instance comprises a plurality of queries including the query, each of the plurality of queries assigned to at least one domain of a plurality of domains.

18. The processor of claim 13, wherein:
the query is a first query, the plurality of fields corresponding to the query are a plurality of first fields, and the plurality of sample responses corresponding to the query are a plurality of first sample responses;
a second training data instance includes a second query linked to the first query, second values corresponding to a plurality of second fields corresponding to the second query, and a plurality of second sample responses corresponding to the second query; and
the one or more circuits are to further update the one or more parameters of the neural network based at least on the plurality of second sample responses, the second values, and a third query comprising the first query and the second query.

19. The processor of claim 13, wherein the neural network comprises at least one of (i) an autoregressive model or (ii) a model having an encoder and a decoder.

20. The processor of claim 13, wherein the processor is comprised in at least one of:
a system of an autonomous or semi-autonomous machine;
an in-vehicle infotainment system of an autonomous or semi-autonomous machine;
a system for performing simulation operations;
a system for performing digital twin operations;
a system for performing light transport simulation;
a system for performing collaborative content creation for 3D assets;
a system for generating or presenting one or more of virtual reality content, augmented reality content, or mixed reality content;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.
